(19) United States
(12) Patent Application Publication
(10) Pub. No.: US 2016/0364733 A1
(43) Pub. Date: Dec. 15, 2016

(54) Attitude Inference

(71) Applicant: International Business Machines Corporation, Armonk, NY (US)

(72) Inventors: Geli Fei, Chicago, IL (US); Jalal U. Mahmud, San Jose, CA (US); Aditya Pal, San Jose, CA (US); Michelle X. Zhou, Saratoga, CA (US)

(73) Assignee: INTERNATIONAL BUSINESS MACHINES CORPORATION, Armonk, NY (US)

(21) Appl. No.: 14/734,670

(22) Filed: Jun. 9, 2015

(51) Int. Cl. G06Q 30/02; G06Q 50/00; G06F 17/18

(52) U.S. Cl. CPC G06Q 30/0201; G06F 17/18; G06Q 30/0202; G06Q 30/0282; G06Q 50/01

(57) ABSTRACT

Embodiments relate to a tool for predicting an attitude of a user towards a target without directly surveying the user. Social media data associated with or related to a target is collected and stored. A set of attitude features are computed from the collected data. A statistical model is built with both the collected data and the assessed attitude features. The statistical data is converted to an attitude prediction, with the prediction emanating from personal and social characteristics as evident in the social media data.

### BACKGROUND

The present invention relates to inferring attitude towards a target. More specifically, the invention relates to constructing a statistical model to predict the attitude towards the target, with the model employing social media data.

There has been growth in forms of electronic communication referred to as social media. Virtual communities are formed and communication in these communities is shared. Such communication includes, but is not limited to, ideas, personal messages, video, and general content. One example of a virtual community is known as a blog, which essential is a web site on which someone writes about personal opinions, activities, and experiences. In a related arena, microblogging is a form of posting electronic content with an increased frequency of brief messages about personal activities.

Product and service brands leverage the growth of the virtual communities to attract potential customers. At the same time, these customers form and express their opinions related to the product and service brands, and post their opinions in these virtual communities. These opinions may express approval, disapproval, or they may be neutral. At the same time, these opinions may have other characteristics, including those related to how recently the opinion was formed, confidence associated with the opinion, etc.

### SUMMARY

The invention includes a method, computer program product and system for inferring attitude.

The method, system, and computer program product function to employ inference as a prediction tool. More specifically, attitude data associated with a target is collected from social media. The collected data is stored at a first memory location. A set of attitude features is formed from the collected data and associated with the attitude components. The features include are selected to depict characteristics associated with attitude evaluation, including but not limited to, n-gram computed from textual communications, general and context based sentiment, recency of mention of a target, and frequency of mention of a target. The computed attitude features are stored at a second memory location. Both the collected data and the computed attitude features are used to construct a statistical model, which is used to predict an attitude towards the target. More specifically, the predicted attitude converts statistical data to a relevant output.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a block diagram illustrating a process for statistical modelling of attitude.

FIG. 2 depicts a flow chart illustrating a process for assigning and computing attitude features for each dimension.

FIG. 3 depicts a block diagram illustrating hardware components of a system for prediction of attitude.

FIG. 4 depicts a block diagram of a computer system and associated components for implementing an embodiment.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Social media is a virtual platform that enables uses to create and share content or to participate in social networking. Users may actively participate in the platform by posting to one or more communities, or users may be passive participants in which they browse these communities to gather information without contributing additional information. A launch of a product or a service may utilize the social media platform and associated communities for marketing or sales, and more specifically as a tool to develop presence of the product or service in both virtual and non-virtual communities. Different tools may be employed by marketing and sales professionals to develop such a presence. At the same time, data populated into the virtual and non-virtual communities with respect to a product, service, or brand may be leveraged to infer an attitude towards the product or service. To infer is defined as a process to deduce or conclude information from evidence and reasoning rather than from explicit statements. The inference leverages the development of the social media communities to build a statistical model as a prediction tool reflecting on behavior. In other words, the success, failure, longevity, etc. of a product, brand, or service may be inferred from the social media data. More specifically, past behavior and opinion as reflected in the social media data and associated with the product, brand, or service is leveraged to predict the attitude. Accordingly, this statistical model adds a dimension into marketing and sales through utilization of the social media data.

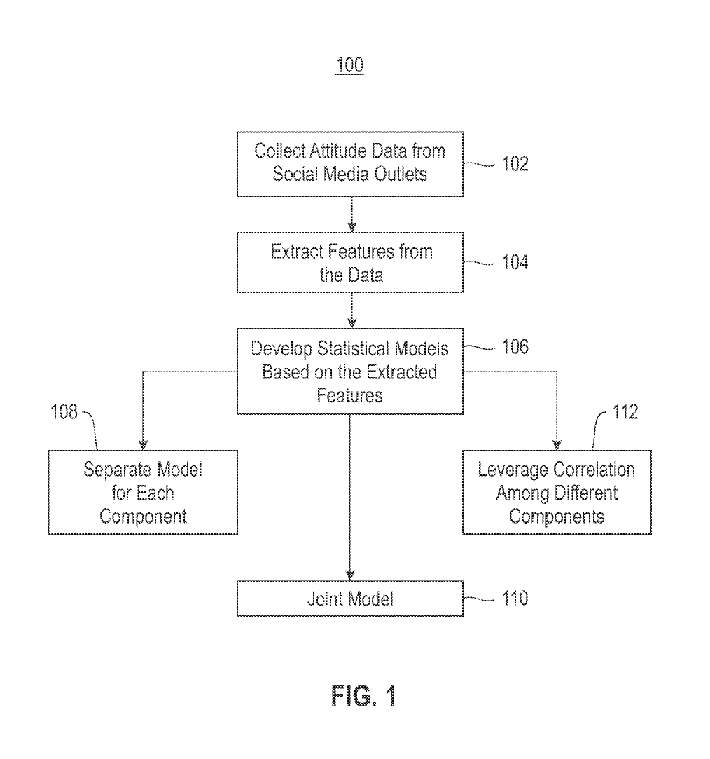

With reference to FIG. 1, a flow chart (100) is provided illustrating a process for statistical modelling of attitude. As shown, attitude data is collected from social media outlets, and specifically data associated with account holders, e.g. users, within the virtual platform (102). In one embodiment, the data is collected by surveys, observations, and/or manual data gathering techniques. One or more features are extracted from the data (104). Details of the features and associated extractions are described below. Based on the extracted features, one or more statistical models are developed (106). More specifically, the extracted data relates to attitude as gathered from the data shown and described in step (102). The model developed at step (106) is employed to predict attitude towards a product, service, or brand through personal and social characteristics. In one embodiment, the predicted attitude is employed for predicting future actions. The statistical models may take on different forms. As shown herein, a separate statistical model may be developed and employed for each component of a multi-component product or service (108), a joint model may be employed wherein one dimension may be used as a basis for prediction of another component or dimension (110), and a correlation among different components may be leveraged (112). In one embodiment, other forms of the statistical modeling may be employed with the gathered data and for the associated prediction, and as such, the modeling shown and described herein should not be considered limiting. Accordingly, data originating from a social media platform is gathered and processed for modeling and producing predictive actions from the model.

The computational model employing modeling techniques is employed to predict an attitude in terms of characteristics, also referred to herein as dimensions. The characteristics include, but are not limited to persistent, favorability, confidence, accessibility, and resistance. A persistent characteristic relates to historical content, including communications that indicate persistence associated with usage of a product, brand, or service. Favorability relates to feeling and sentiment about the target, such as how much a customer likes or dislikes the product, brand, or service. Confidence relates to feelings, and more specifically, data within communications that are representative of feelings, and more specifically strength of the feelings associated with a product, brand, or service. Accessibility relates to how well the subject remembers their attitude toward the product, brand, or service. Finally, resistance is representative of likelihood of a change of attitude towards the product, brand, or service. For example, a loyal customer may be likely to remain with the product, whereas a non-loyal customer or a customer recently frustrated with product quality may have a lower resistance to change. In one embodiment, additional dimensions may be identified or defined for modeling. As such, the dimensions defined herein should not be considered limiting.

Attitude variables may be acquired through survey questions with answers to the questions assessed on a numerical scale, such as, but not limited to a five point scale. Some attitude variables are measured using multiple questions, with a variable representing the responses being an average of the responses for those questions. A high value favorability means the user likes the brand, and a low value means the opposite, e.g. that user does not like or otherwise look favorable towards the brand. A high value of persistence means the user has more persistence of their attitude, while a low value of persistence means the user has less persistence of their attitude. Similarly, a high value of accessibility means the user can remember the attitude easily, and the low value means the opposite, e.g. the user cannot easily remember the attitude. A high value of resistance means the user is more likely to stay with the brand, and a low value means the opposite, e.g. the user is more likely to switch brands. A low value on the response to each action reflects a decreased intent to perform the action, and a high value on the response to each action reflects an increased intent to perform the action.

The defined dimensions are evaluated over a plurality of features. In one embodiment, each dimension is evaluated over a selection of features. Although in another embodiment, a subset of the dimensions is evaluated over a selection of features. With respect to attitude prediction, a set of features are extracted from historical communications associated with the subject, e.g. user. This set of features is an indication of persistence of usage of the target product or service. Examples of the features associated with persistence include, but is not limited to: length of use, frequency of mention, n-gram computation, sentiment, context, and domain. Length is obtained by looking at historical communication and taking a timestamp difference of present time and the oldest mention of the brand under consideration. Frequency of mention relates to keywords specific to the brand under consideration. In the fields of computation linguistics and probability, an n-gram is a contiguous sequence of n items from a given sequence of text of speech. The items can be phonemes, syllables, letters, words, or base pairs, according to the application. The n-grams are collected from a test or speed corpus, e.g. communication. In one embodiment, the n-grams are computed from specific communications that contain a mention of the brand. Sentiment assessment utilizes an associated emotion dictionary which contains a list of words identifying their positive and/or negative polarity as it relates to attitude. The total number of positive and negative words is separately counted. Context pertains to context based sentiment features, and specifically computation of such features for social media which contains the keyword specific to the brand. Finally, the domain relates to domain-specific sentiment features which computes such features for a set of domain specific sentiment words which are learned from social media communications containing a specific keyword to a brand. Specifically, each word which co-occurs with a brand keyword gets a sentiment score, with the score representing how often the keyword appears with the domain word in a positive or negative context. If a positive score for a word outperforms a negative score by a threshold or vice versa, the word is added to a domain specific sentiment dictionary. The features described herein should not be considered limiting. In one embodiment, additional features may be employed for evaluation of the dimensions.

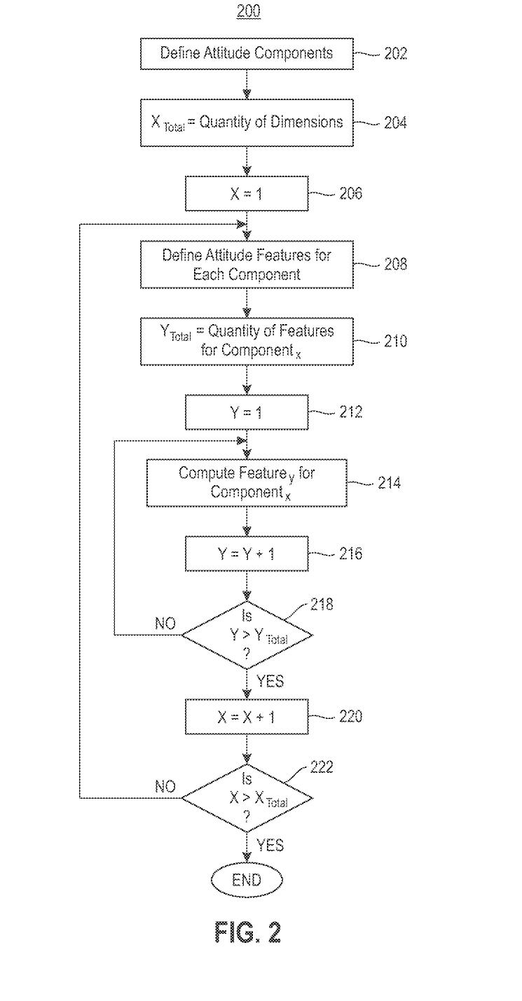

Some or all of the features described above may be associated with each attitude dimension. In one embodiment, additional features may be associated with each dimension. Referring to FIG. 2, a flow chart (200) is provided illustrating a process for assigning and computing attitude features for each dimension. As shown, the attitude components, also referred to herein as dimensions, are defined (202), and the variable X_{Total} is assigned to the quantity of defined dimensions (204). Each dimension has one of more features. The dimension counting variable, X, is initialized (206) and the attitude features are defined for each dimension (208). The quantity of features assigned to the subject dimension, dimension_{X}, is defined (210), and an associated feature counting variable is initialized (212). For each feature in each dimension, a computation is assessed (214). Following step (214), the feature counting variable, Y, is incremented (216) followed by determining if all of the features have been computed for the subject dimension (218). A negative response to the determination at step (218) is followed by a return to step (214). An affirmative response is followed by an increment of the dimension counting variable (220) and an assessment as to whether all of the dimensions have been evaluated (222). A negative response to the determination at step (220) is following at a return to step (208). An affirmative response concludes the assignment and computation process. Accordingly, features for each dimension are defined and assessed to assign a computational value to each dimension, and specifically to each feature in each dimension.

As shown in FIG. 2, each dimension may be comprised of one or more attitude features. The attitude features for each dimension may be pre-defined. The following table lists examples of the attitude feature for the dimension referred to as attitude persistence:

Length of use
Frequency of mention of brand specific keywords
n-grams computed from users historical messages
Sentiment features
Context based sentiment features
Domain-specific sentiment features

The following table lists examples of the attitude features for the dimension referred to as attitude favorability:

n-grams computed from users historical messages
Sentiment features
Context-based sentiment features
Domain-specific sentiment features

The following tables lists examples of the attitude features for the dimension referred to as attitude confidence:

n-grams computed from users historical messages
Sentiment features
Context-based sentiment features
Domain-specific sentiment features
Frequency of mention of brand specific keywords
Recency of mention of brand specific keywords

The following tables lists examples of the attitude features for the dimension referred to as attitude accessibility:

n-grams computed from users historical messages
Sentiment features
Context-based sentiment features
Domain-specific sentiment features
Recency of mention of brand specific keywords

The following tables lists examples of the attitude features for the dimension referred to as attitude resistance:

n-grams computed from users historical messages
Sentiment features
Context-based sentiment features
Domain-specific sentiment features
Recency of mention of brand specific keywords

Accordingly, as shown, the dimensions have different selections and combinations of attitude features that characterize that dimension.

The data gathered for each dimension feature is also referred to herein as attitude ground truth. One or more statistical models are built using the ground truth data to infer each of the dimensions. In one embodiment, one model may be used for each dimension. In one embodiment, noise may be introduced during the model building process.

The following is pseudo code of an iterative classification process. The following terms are employed, the variable x represents different attitude dimensions, with x ranging from x₁ to xₙ. The function p(x) represents a prediction function on attitude dimension x. The variable Cx_basic represents a basic classifier for dimension x, and the variable Cx_expand represents the classifier with expanded features trained for dimension x. There are two aspects to the pseudo code, one aspect is training the basis statistical model and another aspect is testing. The following is the pseudo code for training:

```
For each x in x = 1 to n
      Train Cx_basic using individual features
      Train Cx_expand using individual feature and other dimensions
      as features
```

The following is pseudo code for testing:

```
For each user, u
      For each x in x = 1 to n
            Initialize p(x) using Cx_basic, where p(x) is an attitude
            prediction function
      Repeat
            For each x in x = 1 to n
                  Update p(x) using Cx_expand
                        Update the feature vector of other
                        dimensions using new p(x) until the inferred
                        value from the prior step and the current
                        step converge
```

The statistical models classify whether a user has an attitude towards a brand, and in one embodiment generates a likelihood value as output. Once a model has been applied to a test user, the model can classify the user as either relevant or non-relevant for attitude towards a brand. The model can also output probabilities or likelihood values, which can be used to rank a set of test users in terms of their attitude towards the brand. In one embodiment, one or more relevance dictionaries may be constructed from the training which can be used for feature extraction.

As shown in the pseudo code, statistical models are employed to gather numerical data across the attitude dimension based on computation of the features. In one embodiment, each feature computation has a numerical value within a defined range. Statistics may be applied to the data, including for example computing mean, standard deviation, and correlations between attitude variables and actions. The following table is an example of statistics across the attitude dimensions for a product study:

Correlation

| | | Std. | | | | |
|---|---|---|---|---|---|---|
| | Mean | Dev | 1 | 2 | 3 | 4 |
| Favorability | 3.15 | 1.34 | | | | |
| Persistence | 3.23 | 0.93 | .43 | | | |
| Confidence | 3.68 | 0.94 | .41 | .45 | | |
| Accessibility | 4.21 | 0.67 | .03 | −0.07 | | |
| Resistance | 2.86 | 0.89 | .32 | .17 | .13 | −0.02 |

The correlations as shown herein may be leveraged among different attitude dimensions in the initialization phase of the iterative classification, as shown and described in the pseudo code with respect to the statistical modeling. Similarly, in one embodiment, a threshold value may be set for the confidence values. For example, in one embodiment, the favorability dimension may be predicted for each user, and for all other dimensions. If the basic classifier yields a high confidence in prediction then the basic classified is trusted. Otherwise, trust is placed with the positive correlation, and the prediction dimension is initialized using the favorability dimension.

As shown and described in FIGS. 1-2 and the pseudo code, attitude modeling is constructed as a prediction tool. More specifically, the prediction tool enables social media dashboard or recommendation systems to recommend users with specific attitudes about different brands, products, and services. Knowing such attitudes can help a customer service agent to intervene and influence the customer in a specific direction. In one embodiment, the prediction tool addresses predicting action intentions, which are not observable in social media. The action intentions may not be apparent in the raw social media data. Rather the action intentions are ascertained through assessment of attitude dimension and features from the raw social media data.

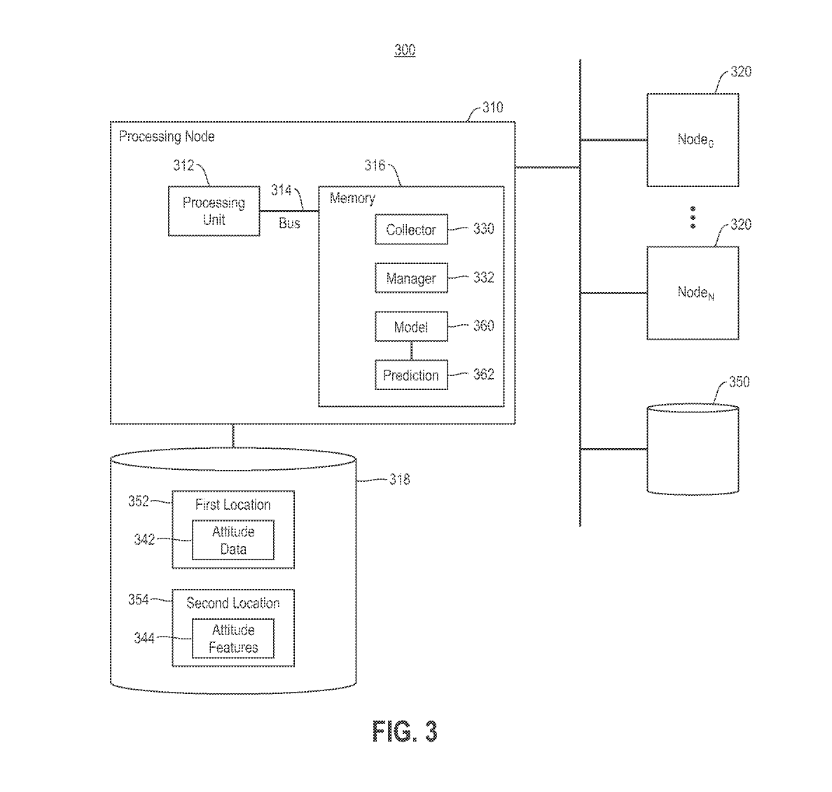

Referring to FIG. 3, a block diagram (300) is provided illustrating hardware components of a system for prediction of attitude. As shown, a processing node (310) is provided with a processor (312), also referred to herein as a processing unit, operatively coupled to memory (316) across a bus (314). The process node (310) is in communication with local persistent storage (318). The processing node (310) is further provided in communication with other nodes (320), which are in communication with persistent storage (350). In one embodiment, the persistent storage (350) is maintained in a data center accessible by both node (310) and other processing nodes (320).

The attitude assessment of communications employs tools in the form of a collector (330) and a manager (332). As shown herein, the tools are local to memory (316), although in one embodiment they may be located in communication with the memory (316). Together, the tools perform prediction of an attitude towards a product, brand, or service. The tool functions to mine social media data, and includes components for mining the social media data and for the attitude prediction. The tools include, but are not limited to, the collector (330) and the manager (332). The collector (330) functions to collect attitude data for attitude components. The attitude data comes from social media. The collected attitude data (342) is stored at a first memory location (352). The manager (332) functions to compute attitude features (344) from the collected data (342). The features include, but are not limited to: n-gram as computed from textual communication, general and context based sentiment, recency of mention, and frequency of mention. The features (344) are stored at a second memory location (354). The attitude data (342) and features (344) are shown storage in separate locations in the local persistent storage (318). In one embodiment, the data (342) and features (344) may be stored at storage location (350), or the data (342) and the features (344) may be separately storage at different storage locations. The collected data (342) and the assessed features (344) are used by the manager to construct a statistical model (360). In one embodiment, a separate statistical model (360) is constructed for each attitude component. Output (362) from the model (360) is referred to as an attitude prediction. More specifically, the prediction (362) is converted from the statistical data. Accordingly, raw social media data is collected and leveraged to statistically evaluate behavior in the form of attitude, so that predictions may accurately reflect behavior.

The collected data (342) and the prediction (362) are stored in separate memory locations. In the example shown herein, the model (360) and the prediction (362) are shown local to memory (316), although this location should not be considered limiting. Similarly, the aspect of collecting data associated with the collector (330) is separate from the functionality of the manager (332). As shown and described, the attitude prediction is based on social media content. The prediction may be static or dynamic. In the dynamic form, the prediction changes as new content is received or collected. In one embodiment, the prediction and associated computations and modeling that support the prediction are fully automated.

One of the goals of the modeling and prediction is to assess whether a user has any attitude toward a brand before recruiting them for a survey. This enables associated survey results to reflect users who are understood to have an attitude towards a brand, so that the survey produces relevant data.

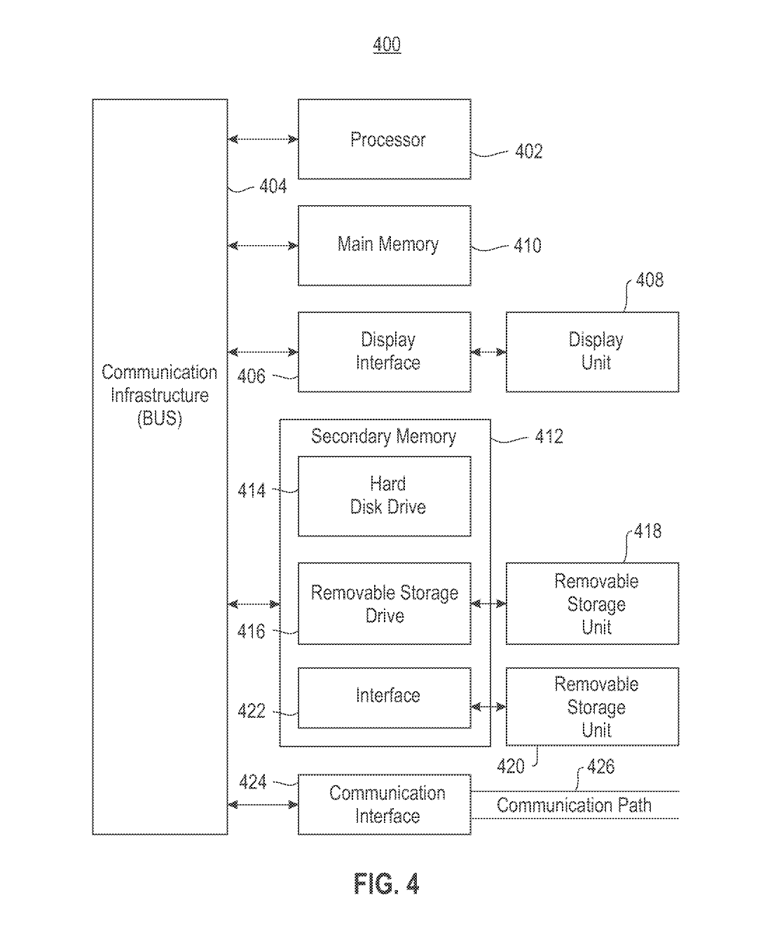

Referring now to the block diagram of FIG. 4, additional details are now described with respect to implementing an embodiment of the present invention. The computer system includes one or more processors, such as a processor (402). The processor (402) is connected to a communication infrastructure (404) (e.g., a communications bus, cross-over bar, or network).

The computer system can include a display interface (406) that forwards graphics, text, and other data from the communication infrastructure (404) (or from a frame buffer not shown) for display on a display unit (408). The computer system also includes a main memory (410), preferably random access memory (RAM), and may also include a secondary memory (412). The secondary memory (412) may include, for example, a hard disk drive (414) and/or a removable storage drive (416), representing, for example, a floppy disk drive, a magnetic tape drive, or an optical disk drive. The removable storage drive (416) reads from and/or writes to a removable storage unit (418) in a manner well known to those having ordinary skill in the art. Removable storage unit (418) represents, for example, a floppy disk, a compact disc, a magnetic tape, or an optical disk, etc., which is read by and written to by removable storage drive (416).

In alternative embodiments, the secondary memory (412) may include other similar means for allowing computer programs or other instructions to be loaded into the computer system. Such means may include, for example, a removable storage unit (420) and an interface (422). Examples of such means may include a program package and package interface (such as that found in video game devices), a removable memory chip (such as an EPROM, or PROM) and associated socket, and other removable storage units (420) and interfaces (422) which allow software and data to be transferred from the removable storage unit (420) to the computer system.

The computer system may also include a communications interface (424). Communications interface (424) allows software and data to be transferred between the computer system and external devices. Examples of communications interface (424) may include a modem, a network interface (such as an Ethernet card), a communications port, or a PCMCIA slot and card, etc. Software and data transferred via communications interface (424) is in the form of signals which may be, for example, electronic, electromagnetic, optical, or other signals capable of being received by communications interface (424). These signals are provided to communications interface (424) via a communications path (i.e., channel) (426). This communications path (426) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (410) and secondary memory (412), removable storage drive (416), and a hard disk installed in hard disk drive (414).

Computer programs (also called computer control logic) are stored in main memory (410) and/or secondary memory (412). Computer programs may also be received via a communication interface (424). Such computer programs, when run, enable the computer system to perform the features of the present invention as discussed herein. In particular, the computer programs, when run, enable the processor (402) to perform the features of the computer system. Accordingly, such computer programs represent controllers of the computer system.

The system described in FIGS. 3 and 4 has been labeled with tools in the form of a collector and a manager (430) and (432). The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments. One skilled in the relevant art will recognize, however, that the embodiment(s) can be practiced without one or more of the specific details, or with other methods, components, materials, etc. In other instances, well-known structures, materials, or operations are not shown or described in detail to avoid obscuring aspects of the embodiment(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of statistical modeling is extended into the realm of social media to assess attitude, and to employ the assessment to generate output in the form of an attitude prediction.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

1. (canceled)

2. (canceled)

3. (canceled)

4. (canceled)

5. (canceled)

6. (canceled)

7. A computer program product comprising a computer readable storage device having computer readable program code embodied therewith, the program code when executed on a processor causes the computer to:
collect data of attitude towards a target for a plurality of attitude components from social media, and store the collected data at a first memory location;
compute a set of attitude features from the collected data associated with the attitude components, the features comprising: n-gram computed from textual communications, general and context based sentiment, recency of mention of a target, and frequency of mention of the target, and store the computed attitude features at a second memory location;
construct a statistical model from the collected data and the computed attitude features for each component; and
predict an attitude towards the target across the components from the constructed statistical model, wherein the predicted attitude converts statistical data to a relevant output.

8. The computer program product of claim 7, wherein the statistical model is a joint statistical model.

9. The computer program product of claim 8, further comprising program code to infer attitude using the joint model, wherein prediction of one component is used as a feature to predict another component.

10. The computer program product of claim 9, further comprising program code to perform an iterative inference until a convergence is reached.

11. The computer program product of claim 7, wherein the program code to construct the statistical model further comprises instructions to leverage a correlation among different attitude components during an initialization phase of iterative classification.

12. The computer program product of claim 7, further comprising program code to apply an attitude relevance model to search for one or more interested entities towards the target, and rank the entities based on attitude towards the target.

13. A system comprising:
a processing unit operatively coupled to memory;
a tool in communication with the processing unit to predict attitude to a target, including:
a collector to collect data of attitude towards a target for a plurality of attitude components from social media, and to store the collected data at a first memory location;
a manager to compute a set of attitude features from the collected data associated with the attitude components, the features comprising: n-gram computed from textual communications, general and context based sentiment, recency of mention of a target, and frequency of mention of the target, and to store the computed attitude features at a second memory location; and
the manager to construct a statistical model from the collected data and the computed attitude features for each component; and
an attitude prediction towards the target as output from the statistical model, wherein the attitude prediction is converted from statistical data to a relevant output.

14. The system of claim 13, wherein the statistical model is a joint statistical model.

15. The system of claim 14, further comprising the manager to infer attitude using the joint model, wherein prediction of one component is employed by the manager as a feature to predict another component.

16. The system of claim 15, further comprising the manager to perform an iterative inference until a convergence is reached.

17. The system of claim 13, wherein construction of the statistical model further comprises the manager to leverage a correlation among different attitude components during an initialization phase of iterative classification.

18. The system of claim 13, further comprising the manager to apply an attitude relevance model to search for interest towards the target, and to rank a plurality of interested entities.
